(19) United States
(12) Patent Application Publication
(10) Pub. No.: US 2011/0111309 A1
(43) Pub. Date: May 12, 2011

(54) FUEL CELL SYSTEM

(75) Inventors: Craig Peter Jacobson, Moraga, CA (US); Michael Cook Tucker, Berkeley, CA (US); Tal Zvi Sholklapper, West Hills, CA (US)

(73) Assignee: POINT SOURCE POWER, INC., Alameda, CA (US)

(21) Appl. No.: 12/871,473

(22) Filed: Aug. 30, 2010

Related U.S. Application Data
(60) Provisional application No. 61/259,685, filed on Nov. 10, 2009.

(51) Int. Cl. H01M 8/06; B23P 11/00

(52) U.S. Cl. 429/408; 429/535

(57) ABSTRACT

A system for generating electrical power includes a fuel storage container having an inside and an outside including a wall including a heat conducting region configured to allow heat from an external heat source to be conducted into the fuel storage container. The system further includes a fuel cell region associated with a fuel cell having two sides, one side of the fuel cell exposed to the outside of the fuel storage container and one side of the fuel cell exposed to the inside of the fuel storage container, wherein the wall is configured to isolate the inside of the fuel storage container from the environment outside the fuel storage container. The system further includes an opening for receiving a fuel load for storage in the fuel storage container, the fuel cell having two sides, and an electrical connection providing access to power generated by the fuel cell.

### CROSS REFERENCE TO OTHER APPLICATIONS

This application claims priority to U.S. Provisional Patent Application No. 61/259,685 (Attorney Docket No. PSPIP001+) entitled FUEL CELL filed Nov. 10, 2009 which is incorporated herein by reference for all purposes.

### BACKGROUND OF THE INVENTION

To generate an electrical current, a fuel cell typically needs at least oxygen and fuel. Oftentimes the fuel is a gas (e.g., hydrogen and methane) or a liquid (e.g., methanol, ethanol, dimethyl ether, gasoline, etc.) and the system is designed for refined gaseous or liquid fuels. Refined fuels are more expensive than raw or unprocessed fuels because the purification process adds to the cost. Refined fuels also limit the usage of a fuel cell system since the fuel cell must be resupplied with the processed fuel, which is not always readily available. For example, it would be difficult to use a fuel cell system in inaccessible or remote areas since the refined fuel must be brought out to these remote locations. In some cases there may be no road, the road may be in poor condition, or there may be other factors restricting the transport of processed fuels (e.g., border crossings, bandits, etc.). It would be desirable to develop new fuel cell systems which are not limited to refined gaseous or liquid fuels. Such fuel cell systems may be cheaper to operate and/or may be used in many more locations compared to other fuel cell systems.

### BRIEF DESCRIPTION OF THE DRAWINGS

Various embodiments of the invention are disclosed in the following detailed description and the accompanying drawings.

FIG. 1 is a diagram showing an embodiment of a fuel cell system capable of operating on solid fuels and generating electrical power.

FIG. 2 is a flowchart illustrating an embodiment of a process for building a fuel cell system which is able to operate using solid and/or unrefined fuel.

FIG. 3A is a diagram showing some embodiments of fuel cells attached to a fuel storage container in a permanent manner.

FIG. 3B is a diagram showing some embodiments of fuel cells attached to a fuel storage container in a removable manner.

FIG. 4 is a diagram showing some embodiments of attaching an electrical connection (for example a wire) to a fuel cell.

FIG. 5 is a diagram showing some embodiments of lids.

FIGS. 6A and 6B are diagrams showing some embodiments of two fuel cells connected together in a fuel cell system.

FIG. 7 is a diagram showing an embodiment of a fuel cell system with a removable fuel cell card.

FIG. 8 is a diagram showing an embodiment of a cylindrical fuel storage container.

FIG. 9 is a diagram showing an embodiment of a fuel storage container in the shape of concentric cylinders.

### DETAILED DESCRIPTION

The invention can be implemented in numerous ways, including as a process; an apparatus; a system; and/or a composition of matter. In this specification, these implementations, or any other form that the invention may take, may be referred to as techniques. In general, the order of the steps of disclosed processes may be altered within the scope of the invention. Unless stated otherwise, a component described as being configured to perform a task may be implemented as a general component that is temporarily configured to perform the task at a given time or a specific component that is manufactured to perform the task.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

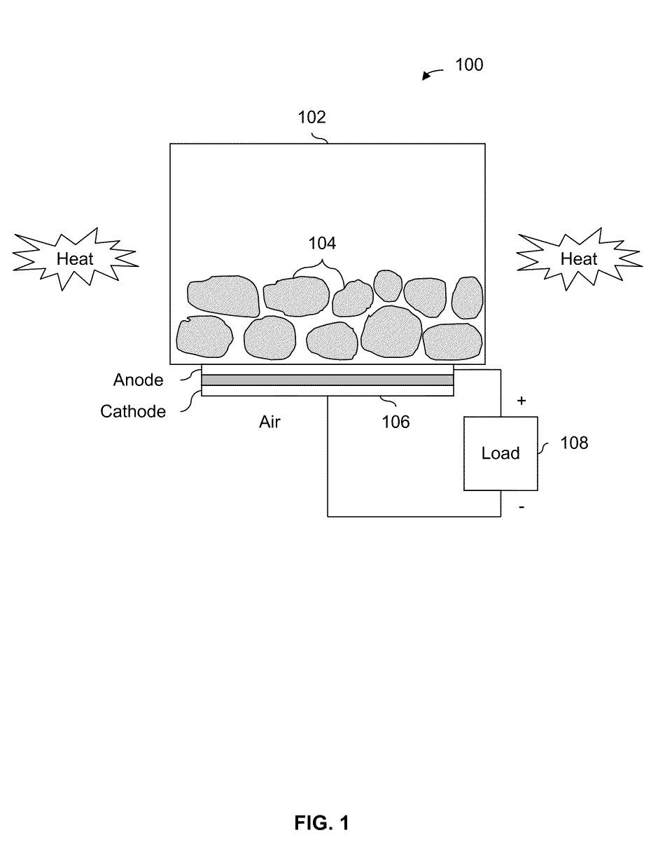

FIG. 1 is a diagram showing an embodiment of a fuel cell system capable of operating on solid fuels and generating electrical power. In various embodiments, a fuel cell system can be various sizes or dimensions. In some cases, a fuel cell system is a relatively small device (e.g., 10 cm×6 cm×2.5 cm) and the fuel cell system is designed to power a relatively small load (e.g., an LED light or a cell phone). In some embodiments, a fuel cell system is a relatively large device (e.g., on the order of 10's to 100's of centimeters) and the fuel cell system is configured to power a relatively large load (e.g., a house). In the example shown, fuel cell system 100 includes fuel storage container 102. The fuel storage container has an inside and an outside. The fuel storage container is configured to allow heat from a heat source on the outside of the container to be conducted into the container. The heat source can be from a combustion process, such as burning biomass or fossil fuels (in an open fire, cookstove, combustion chamber, combustion engine, or other means), or from any other means including concentrated solar or waste heat from nuclear reactions. The fuel 104 inside the fuel storage container is heated by the heat source and provides energy for reactions occurring in the container. The heat also brings the fuel cell to the necessary operating temperature for the thermally activated electrochemical processes.

In some embodiments, fuel 104 is loaded into fuel storage container 102 in batches (e.g., as opposed to continuously). For example, if fuel 104 is a solid fuel then a batch of solid fuel may be added and the next batch is added when fuel 104 has been at least partially consumed. In some embodiments, fuel 104 is solid fuel and is biomass (biological material derived from living, or recently living organisms, such plant materials and animal waste), such as wood, straw, rice hulls, grass, charcoal, or solid waste (human or animal) or is derived from biomass, such as paper. Coal or other fossil fuels can also be used. In some embodiments, a liquid is added to the solid fuel to act as a carrier by mixing a powder or other relatively small solids (e.g., carbon fines such as charcoal dust) with a liquid (such as water) and the liquid mixture is introduced (e.g., pouring, using a syringe, funnel, etc.) into fuel storage container 102. In various embodiments, fuel can be inserted into fuel storage container 102 while still in a “hot zone” or after being removed from the heat. As described above, fuel cell system 100 is able to operate using solid fuel for fuel 104 and it is not necessary to use fuels such as refined gases or liquids.

In this particular example, fuel storage container 102 is cube-like but any shape can be used including (but not limited to) polyhedra, rectangular prism, spherical, cylindrical, or conical. Although not shown in this example, a fuel storage container in some embodiments includes one or more openings in which fuel is loaded into fuel storage container 102. In some embodiments, fuel storage container 102 has a lid; in some other embodiments a fuel storage container has no lid. In some embodiments, the fuel storage container is made of a flexible or bendable material and has an opening that crimps or rolls over (e.g., like a bag of coffee).

Attached to fuel storage container 102 is fuel cell 106 having two sides. One side of the fuel cell is exposed to the outside of the fuel storage container and one side of the fuel cell is exposed to the inside of the fuel storage container Some embodiments showing how a fuel cell is connected to a fuel storage container are described in further detail below. The anode of fuel cell 106 faces towards the interior of fuel storage container 102 and the cathode of fuel cell 106 faces away from the interior of fuel storage container 102. In some embodiments, a fuel cell is attached to the inside of a fuel storage container as opposed to the outside (as is shown in this figure). The “anode” and “cathode” of the fuel cell include the electrochemically active regions where oxidation or reduction occurs during operation, as well as additional materials or layers used for mechanical support, electrical collection, gas diffusion management, etc. In some embodiments, the fuel cell used is a solid oxide fuel cell (SOFC). A SOFC is a fuel cell in which the electrolyte is a solid that conducts ions at the operating temperature. Typical SOFC electrolytes are oxygen-ion (other ion conducting electrolytes can be used) conducting ceramics such as doped zirconia or doped ceria. In some embodiments, the fuel cell used is a metal-supported SOFC; some example metal-supported SOFCs are described in US Publication No. 2010/0143824, and U.S. Pat. No. 6,767,662 which is hereby incorporated by reference for all purposes. Metal-supported SOFCs comprise a thin electrolyte layer mechanically supported on a metal support. There may also be an intervening electrochemically active electrode layer between the electrolyte and metal support. The metal support is typically porous or perforated to allow gas access to the electrode. Electrical current developed at the electrode passes through the metal support before exiting the fuel cell via external electrical connections. In some embodiments, the fuel cell is a symmetric structure fuel cell. In this case the thickness, porosity, layered structure, particle size, dimensions, and/or other features of the anode and cathode are identical or do not differ significantly. For example, the anode and cathode may both comprise a thin porous ceramic layer and a thicker porous metal layer, wherein the thickness and porosity of the ceramic and metal layers are the same for both anode and cathode. In some embodiments, the fuel cell is a symmetric catalyst composition fuel cell. In this case, the composition of the anode and cathode electrocatalyst are the same or do not differ significantly. In one embodiment, the fuel cell has both a symmetric structure and a symmetric catalyst composition. In some embodiments, the fuel cell is a thin film electrolyte fuel cell. A thin film electrolyte fuel cell has a thin electrolyte layer between the cathode and anode. At least one of the anode, cathode, or support, is much thicker than the electrolyte and provides mechanical support for the electrolyte. Thin film electrolytes are less than 100 micrometers, and typically less than 50 micrometers thick. A particularly useful range of thin film electrolyte thickness is 5-30 micrometers. Thin film fuel cells typically provide more electrical power at a given operating temperature, or similar power at a lower operating temperature, than fuel cells with a thicker electrolyte. In some embodiments, there is a protective layer over the anode and another protective layer over the cathode of a fuel cell. Put another way, in some embodiments there is an additional exterior layer covering the cathode and/or anode which are not shown in this figure. In some embodiments, these additional layers help to protect the fuel cell from physical or thermal shocks.

Electrical connections provide access to electrical power generated by the fuel cell. In FIG. 1 a first electrical connection is connected to the anode and a second electrical connection is connected to the cathode of fuel cell 106. The electrical connections can be wires, strips, tabs, meshes or any other configuration. In some embodiments, either anode or cathode of the fuel cell 106 is electrically connected to the fuel storage container 102, for example by a weld, braze, mechanical connection, or electrically conductive sealant. In this case an electrical connection that connects to the load 108 may optionally be connected to the fuel storage container 102 or directly to the either anode or cathode of the fuel cell 106. The combination of heat, fuel 104, and air cause fuel cell 106 to generate a voltage and current which in turn runs through the electrical connections and causes load 108 to be powered. Load 108 can be any load, including a rechargeable battery, cell phone, light, radio, television, refrigerator, sensor, transmitter, etc. In some embodiments, there is a plug, connector, or jack so that a desired load can be temporarily coupled to the electrical connections (e.g., plugged in and then unplugged). In other embodiments multiple fuel cell systems are connected in series and/or parallel by the electrical connections.

The fuel cell system described herein has a variety of applications. In developed countries where there is an electrical and/or refined fuel infrastructure in place, the fuel cell system may be used when a person is “off the grid.” For example, recreational users may use the system to provide light, power a radio, charge a battery, and such when camping, hunting, or fishing. The system may also be used as back-up power during periods of grid failure or emergency response situations. In some cases, people live “off the grid” and must generate their own power. In some embodiments, the fuel cell system is used to power televisions, refrigerators, water purifiers, lights, batteries, and other electrical devices in a home that is “off the grid.” In another example application, the fuel cell system described herein is used as an emergency device when the power goes out. It can be used during storms or other electrical outages to charge or power flashlights, cell phones, radios, or other electronic devices. In less developed countries, the fuel cell system described herein is useful since there may be no infrastructure or the power supply may be erratic and/or unavailable during certain times. Some examples of users in less developed countries include rural or semi-urban dwellers, aid/NGO workers, military personnel, etc.

In the above example applications, refined fuels would be inconvenient to use. For example, campers will often hike into an area carrying all of their supplies and having to carry gaseous or liquid fuel (typically in heavy, metal containers) over rough terrain would be inconvenient. In less developed countries, access to refined fuel would be severely limited. One benefit of the fuel cell system described herein is that unrefined and/or solid fuels can be used. In some embodiments, the fuel used is biomass or derived from a biomass which has the benefit of being readily available to campers or people living in less developed areas. Some examples include human and/or animal solid waste (e.g., cow dung), charcoal, wood, grass, hay, trash or byproducts (e.g., rice or corn husks, paper, old food, etc.), algae, a biogas derived from organic matter, etc. This may be attractive since the fuel source is sustainable, has a smaller carbon footprint compared to other power generation techniques (e.g., burning fossil fuels or coal), is readily available, and/or is cheap.

In some embodiments fuel cell system 100 rests upon or is nestled within or below a solid fuel source of the heat source. For example, the fuel cell system may be buried beneath or surrounded by or set on top of hot coals in a fire. Positioning a fuel cell system in that manner within a fire or other heat source may result in a relatively constant temperature being applied to fuel cell 106 which in turn results in steadier and/or larger electrical current. Relatively large swings in temperature may, for example, result in periods where there is no or little electrical current produced by the fuel cell system. Such swings in temperature may occur when the fuel cell system is in the flames or in the hot air region (i.e., above the flames) of a heat source. In some embodiments, the fuel used to provide heat is the same type of fuel as that which is put into fuel storage container 102. For example, fuel cell system 100 may be nestled in a fire created by burning charcoal and the same type of fuel (i.e., charcoal) is put into fuel storage container 102 as fuel 104. In some other embodiments, the fuels are different. For example, cow dung may be put into fuel storage container 102 as fuel 104 and fuel cell system 100 is put into a fire created by burning charcoal. A cookstove is a common source of heat in developing countries and the fuel cell system may be operably attached, placed within, or mounted to a cookstove.

In some embodiments, some or all of the components in system 100 are coated, for example with a ceramic, glass, or glass-ceramic. Coating some or all of the components in system 100 can increase the useable lifetime of the components, prevent unwanted interactions between the fuel and the component, and provide an appealing look to the device. The coating may also prevent short-circuiting between adjacent metal components.

In some embodiments, an outer metal sleeve is designed to fit around fuel storage container 102 and fuel cell 106 and protect the system. Such a metal sleeve permits heat to pass through it to the fuel cell system but prevents damage to fuel storage container 102 and fuel cell 106. For example, in a large fire, large logs may be tossed into the fire or someone may use a metal poker to stir a fire and either of these could damage the fuel storage container and/or the fuel cell.

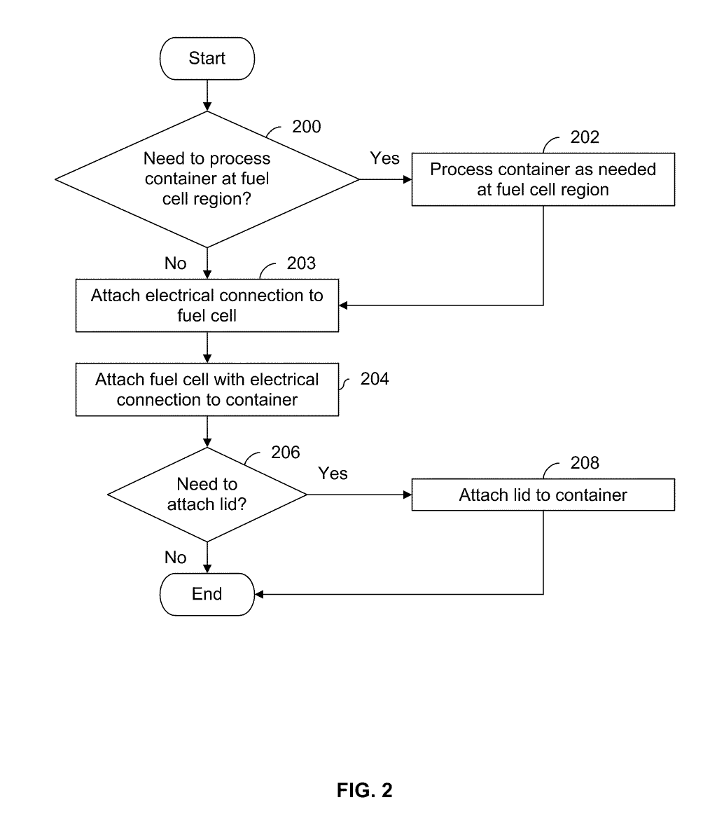

FIG. 2 is a flowchart illustrating an embodiment of a process for building a fuel cell system which is able to operate using solid and/or unrefined fuel. At 200 it is determined if there is a need to process a fuel storage container at a fuel cell region. As used herein, the fuel cell region is the portion of a fuel storage container that is connected to or in the vicinity of a fuel cell. In some embodiments, a fuel storage container is manufactured in the necessary form (e.g., cast, drawn, or stamped to have the desired vents, holes, etc.) so that the cathode of the fuel cell has exposure to air or so that the anode has sufficient exposure to the fuel coming from the fuel storage container (depending upon how the fuel cell is connected to the fuel storage container). In some other embodiments, a fuel storage container is manufactured without holes or vents and the fuel storage container needs to be processed to create the desired form. If it is determined at 200 that processing is needed then at 202 a fuel storage container is processed as needed at a fuel cell region. Some examples include cutting, sawing, puncturing, etc.

Electrical connections are attached to the fuel cell at 203. For example, a first electrical connection may be welded to the anode and a second electrical connection may be welded to the cathode. The electrical connections in turn connect the fuel cell system to a load (although at the time the electrical connections are attached there may be no load connected). A variety of materials and techniques may be used to attach the electrical connections to the fuel cell; some embodiments are described in further detail below. In some embodiments, one side of the fuel cell is electrically connected to the fuel storage container (i.e. by welding, brazing, electrically conductive sealant, etc). In this case the electrical connection may directly contact that side of the fuel cell, or may optionally be attached to the fuel storage container.

At 204, the fuel cell with the electrical connection is attached to the fuel storage container. In some embodiments, a fuel cell is first attached to another material or surface (e.g., a metal mesh or sheet) and then the material with the fuel cell is attached to the fuel cell container. In some embodiments, the fuel cell is attached to a fuel storage container in a removable manner. This is desirable in some applications since the performance of the fuel cell will decrease with use and attaching the fuel cell in a removable manner permits an old fuel cell to be replaced with a new cell (e.g., because the cost of the fuel cell is relatively small compared to the rest of the fuel cell system, or because the fuel cell system is large, heavy, or otherwise difficult to move). In some embodiments, a fuel cell is attached to a fuel storage container in a permanent manner. In such embodiments, the fuel cell system may be disposable and is discarded once the fuel cell is exhausted. In various embodiments, a variety of techniques (including various materials and/or hardware) may be used to attach a fuel cell to a fuel storage container (including permanently if desired). Some embodiments are described in further detail below.

At 206 it is determined whether a lid needs to be attached. In some embodiments, a fuel cell system has no lid and there is no need to attach a lid. For example, some fuel cell systems may be designed to stand upright in the middle of a fire (e.g., nestled within the wood or charcoal of the fire) and no lid is necessary to prevent the fuel from falling out of the fuel storage container. In some other embodiments, a fuel cell system has a lid but the container is manufactured or otherwise comes with the lid already attached. For example, in some embodiments, a box with a hinged lid (e.g., similar to a mint tin) is used as the fuel storage container and the box already comes with the lid attached. In other embodiments the fuel cell is attached in a removable manner and is the lid. If need, a lid is attached to the container at 208. The specific technique used to attach the lid may vary with the particular lid used; some example lids are described in further detail below.

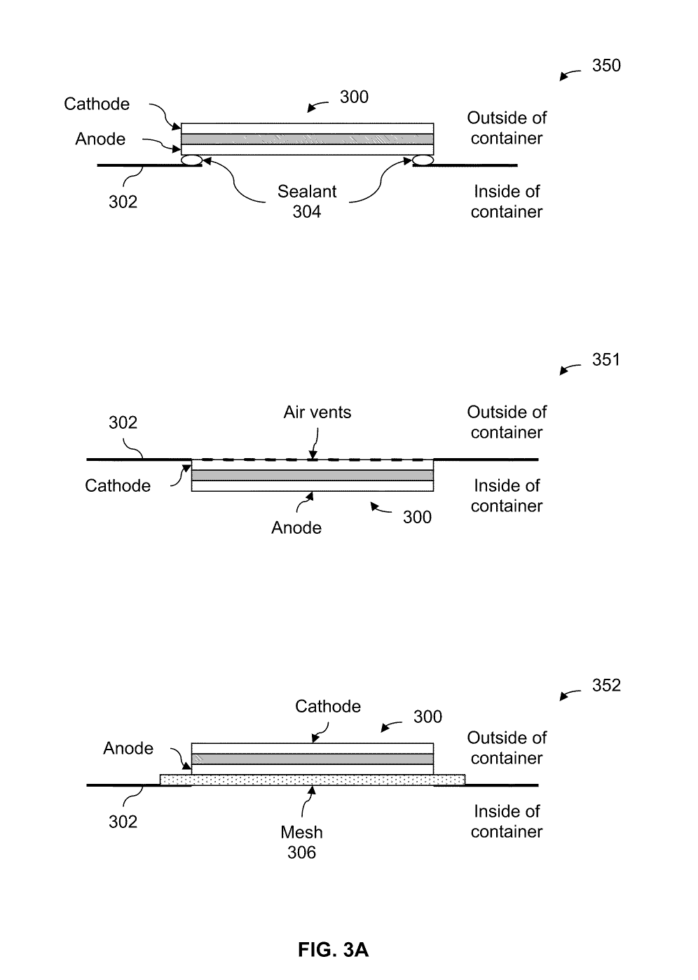

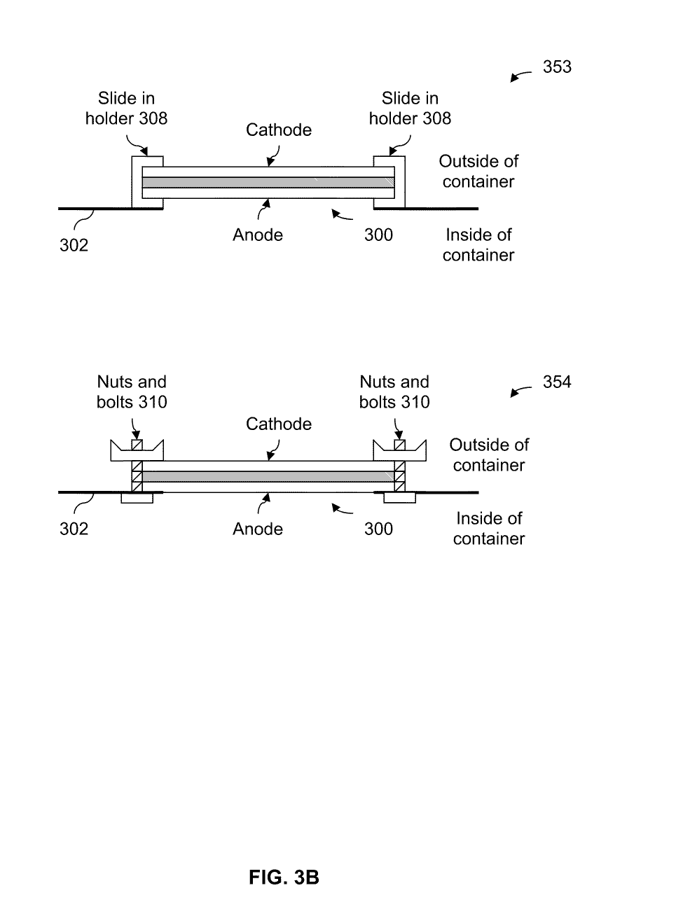

FIG. 3A is a diagram showing some embodiments of fuel cells attached to a fuel storage container in a permanent manner. In some embodiments, the techniques shown are used at step 204 of FIG. 2 to manufacture disposable fuel cell systems. For clarity, some other components of a fuel cell system (e.g., electrical leads) are not shown.

Diagram 350 shows a fuel cell (300) attached to a fuel storage container using sealant (304). In various embodiments, various ceramic or glass sealing materials are used, such as: Fire Block Sealant FB 136 made by 3M; glass sealing materials made by Schott, SEM-COM, Kerafol and others; ceramic-containing adhesives and potting compounds and others from Aremco (such as Ceramabond 552 and 503), Cotronics, and others. Such materials may be attractive because they are rugged and are able to withstand repeated thermal and mechanical shocks without failing. In some embodiments, the sealant has the physical property of adhering fuel cell 300 to fuel storage container 302 and/or has the electrical property of electrically insulating the anode side of fuel cell 300 from container 302. In such embodiments where sealant 304 is an electrical insulator, fuel storage container 302 would not be in electrical contact with the anode. In such embodiments where sealant 304 is an electrical conductor, fuel storage container 302 would be in electrical contact with the anode. In this case, electrical leads providing electrical connection to the anode may be attached to the fuel storage container 302, rather than directly to the anode. In some embodiments, the cell 300 is welded, brazed, or otherwise joined to the fuel storage container 302. If the joint area is porous or otherwise not hermetic, sealant may be added to the joint area to improve the seal.

In this example, the wall of the fuel storage container has a hole or opening slightly smaller than fuel cell 300. The hole may be formed after the container is manufactured (e.g., by cutting it out, punching, stamping, drilling, etc.) or the container may be manufactured with the hole (e.g., by casting, stamping or drawing it to have a hole). In this example, fuel cell 300 is attached to the outside of the container with the cathode facing outwards and the anode facing inwards. Although some example described herein may show a fuel cell attached to the inside (outside) of a fuel storage container, a fuel cell may be attached to the outside (inside) of a fuel storage container as desired.

Diagram 351 shows a fuel cell (300) attached to the inside of a fuel storage container with the cathode of the fuel cell facing outwards and the anode facing inwards. In this example, the fuel cell region of container 302 has air vents. The air vents may be created after manufacturing by puncturing or cutting, or during the manufacturing process itself. In some other configurations, the vents may be referred to as “fuel vents” because the vents permit fuel to pass to the anode of the fuel cell (as opposed to permitting air to pass to the cathode of the fuel cell).

Diagram 352 shows fuel cell 300 attached to fuel storage container 302 using mesh 306. In some embodiments, the mesh is porous and permits fuel to reach the anode of fuel cell 300 from the inside of fuel storage container 302. In some embodiments, the mesh is a stainless steel mesh (e.g., AISI 300 series or AISI 400 series stainless steel). In some applications, steel is an attractive material to use in a mesh since it can tolerate high temperatures and can withstand rough handling.

The examples shown herein are merely exemplary and may be combined as desired. For example, in some embodiments, a sealant is used to attach fuel cell 300 to mesh 306 and/or to attach mesh 306 to container 302.

FIG. 3B is a diagram showing some embodiments of fuel cells attached to a fuel storage container in a removable manner. In some embodiments, the techniques shown are used at step 204 of FIG. 2 to manufacture fuel cell systems with replaceable fuel cells. This may be desirable in some applications because of cost and/or portability reasons (e.g., because the fuel cell system is heavy, bulky and/or expensive). For clarity, some components of a fuel cell system (e.g., electrical connections) are not shown.

Diagram 353 shows fuel cell 300 attached to fuel storage container 302 using slide in holder 308. In various embodiments, slide in holder 308 is attached to container 302 using a variety of materials and/or techniques, such as welding, sealant, etc. In another embodiment, the holder may be fabricated from the same body as the fuel storage container, for example by drawing, crimping, stamping, etc. In the example shown, holder 308 is attached to the outside of container 302 and fuel cell 300 is inserted into the holder with the cathode facing outwards and the anode facing inwards. In this example, the fuel cell region of container 302 has a hole slightly smaller than fuel cell 300. As described above, the techniques shown in the figures may be combined as desired. For example, a slide in holder may be combined with air vents (as opposed to a hole as shown in 353) and/or the slide in holder may be attached to the inside of container 302 (as opposed to the outside as shown in 353).

In some embodiments, slide in holder 308 is manufactured so that there is some gap between fuel cell 300 and slide in holder 308. This may permit easier insertion of a fuel cell and/or prevent the fuel cell and/or holder from being damaged because of scraping. In some embodiments, the gap is partially or completely filled with an electrical insulator, such as ceramic wool or insulating sealant, to prevent short-circuiting between the anode and cathode of the fuel cell 300.

Diagram 354 shows fuel cell 300 attached to container 302 using nuts and bolts 310. In this example, the nut is a wing nut which permits the nut to be easily tightened or loosened. The wing nut is loosened to remove fuel cell 300 and to secure fuel cell 300 is tightened. In some embodiments, a flexible and/or fireproof material is used to cushion fuel cell 300 so that the hardware does not damage the fuel cell. For example, a non-conducting, heat resistant material may be wrapped (e.g., around the edges of fuel cell 300 where nuts and bolts 310 would make contact or around the entire fuel cell) and then the fuel cell in its wrapping would be attached to container 302 using nuts and bolts 310. In some other embodiments, other hardware fasteners such as screws, washers, ties, or clips may be used in addition to or as an alternate to the hardware shown. In some embodiments, an electrical insulator, such as ceramic wool or insulating sealant, is inserted between the hardware and fuel cell 300 to prevent short-circuiting between the anode and cathode of the fuel cell 300. The insulator may contact both the anode and cathode, so that the fuel cell 300 is isolated from the fuel storage container, or only one of the anode and cathode, so that one electrode is electrically connected to the fuel storage container.

Slide in holder 308 and nuts and bolts 310 are some examples of hardware. Some other examples of hardware include nails, screws, clips, springs, and latches.

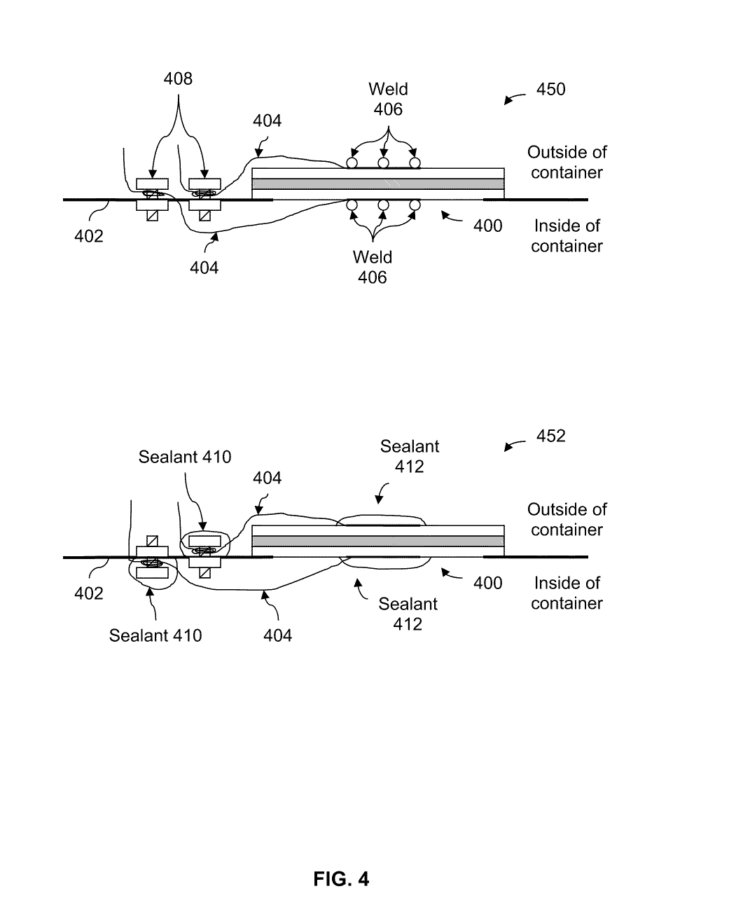

FIG. 4 is a diagram showing some embodiments of attaching an electrical connection (for example a wire) to a fuel cell. In some embodiments, the techniques shown are used at step 203 in FIG. 2. For simplicity, diagrams 450 and 452 are shown with fuel cell 300 attached directly over a hole in container 302. The techniques shown here may be combined with other techniques described herein (e.g., attaching a fuel cell on the inside of the container, having air vents instead of a single hole, using sealant and/or a mesh to attach the fuel cell to the container, etc.).

In diagram 450, electrical connections 404 are attached to the cathode and anode of fuel cell 400 by weld 406. In some embodiments, the electrical connections are connected to the fuel cell before fuel cell 400 is attached to container 402. In various embodiments, electrical connections 404 may be welded directly to fuel cell 400 or via one or more intermediary components that provide an electrical connection to fuel cell 400.

Away from weld 406, the electrical connections are each attached respectively to a nut/bolt pair (408) by being wrapped around the shank. In some embodiments, at least one of the bolts is coated with an electrical insulator (to prevent electrical shorting), such as a ceramic, glass, or sealant prior to wrapping an electrical connection around the bolt. In such embodiments, the other bolt may be similarly coated or left uncoated. For clarity, nuts and bolts 408 in this figure are shown one above the other. In actuality, nuts and bolts 408 are not necessarily limited to any particular location (e.g., relative to each other or with respect to the container or fuel cell). In some other embodiments, other hardware such as screws, nails, studs, pins, tabs, or hooks may be used to secure an electrical connection instead of nuts and bolts. One of the electrical connections 404 may also be welded, brazed, or otherwise joined directly to the fuel storage container 402. This is especially useful if the fuel cell is in electrical contact with the fuel storage container 402 by means of a weld, braze, electrically conductive sealant, mechanical connection, etc.

In diagram 452, electrical connections 404 are attached to fuel cell 400 by applying sealant 412 over the electrical connection and the cathode or anode. As in diagram 450, electrical connections 404 are wrapped around nuts and bolts 410 but in this example one of the nut and bolt pairs is inserted from the inside of the container towards the outside. After wrapping electrical connection 404 around shank of the bolt, a sealant (410) is applied over the head of the bolt.

Securing an electrical connection as shown herein may be desirable because some people may pick up a fuel cell system by the electrical connection; attaching the electrical connections in a secure manner may be desirable so that the device does not break.

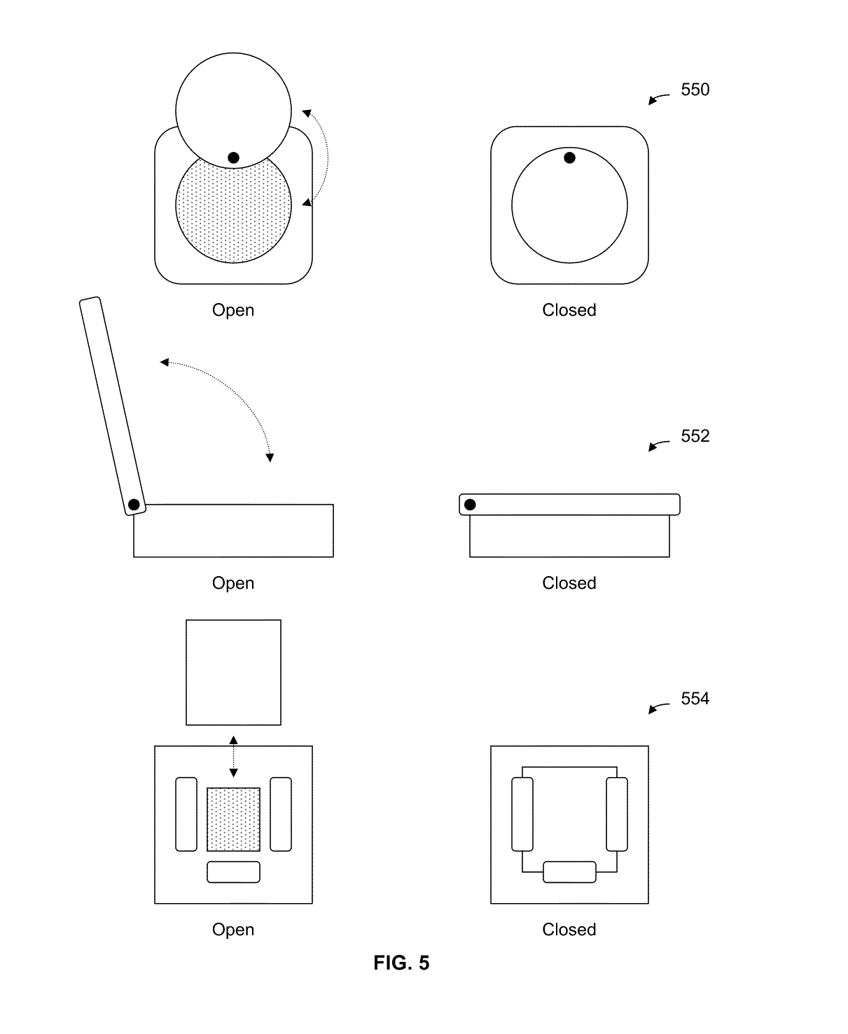

FIG. 5 is a diagram showing some embodiments of lids. In some embodiments, a fuel cell system includes a lid (e.g., to prevent fuel from falling out of a fuel storage container) and some example lids are shown. The lids shown are merely exemplary and may (for example) be attached to any shape of container. The lid may contain one or more fuel cell regions, and a fuel cell card may be used in place of the lid.

Diagram 550 shows a rotating lid attached with a pin. The plane of the lid and the plane of the surface of the container to which the lid is attached are parallel (both when the lid is open and when the lid is closed). In some embodiments, a clasp, lock, or other mechanism is used to secure the lid when it is in a closed position. In other embodiments, the lid is attached to the container by press-fit, twist-lock, or screwing it onto threads. In another embodiment the lid is simply placed on the container and held in place by gravity.

Diagram 552 shows a lid which swings open. The lid is attached to the container via a rod running through the lid and the container. In some embodiments, the container has a small protrusion or “lip” that the lid latches onto so that the lid does not swing open freely when it is in the closed position. In some other embodiments, some other mechanism is used to keep a lid closed.

Diagram 554 shows a lid which slide in and out of a holder. In the example shown, the holder comprises a plurality of parts but in some embodiments is a single holder (e.g., extending along the left side of the opening, below the opening, and wrapping around the right side of the opening). In some cases, labor may be cheap compared to materials and it may be desirable to use multiple pieces (as shown in 554) which saves on materials. In some other cases, labor is expensive compared to materials and a single piece is used for the holder. As in the previous examples a lock, clasp, latch or other mechanism may be used if desired to secure a lid in the closed position.

In some embodiments, an electric load requires a minimum voltage which exceeds the voltage capable of being produced by a single fuel cell. For example, a load may require 2V but a fuel cell may only be able to supply 1V. To overcome this, in some embodiments a plurality of fuel cells are connected in series in a single fuel cell system. For example, if two 1V fuel cells are connected together in series then the system will be able to produce the desired 2V. In some embodiments, multiple fuel cell systems (each system having one or more fuel cells in series) are connected to each other in series. In some embodiments, a system includes fuel cells connected together in parallel. Connecting fuel cells in parallel may be useful for redundancy or reliability reasons and/or to increase the amount of current supplied. In some embodiments, a fuel cell system is connected to another fuel cell system in parallel. The following figure shows some examples of how two or more fuel cells can be connected together (either in parallel or series) in a fuel cell system.

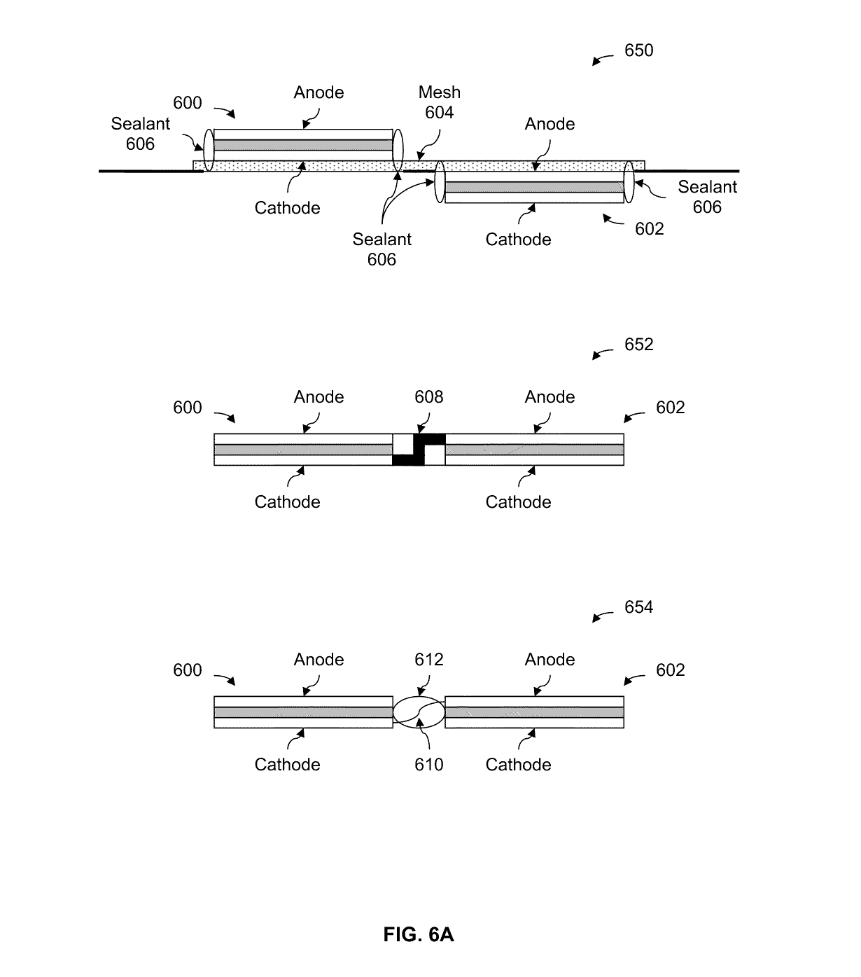

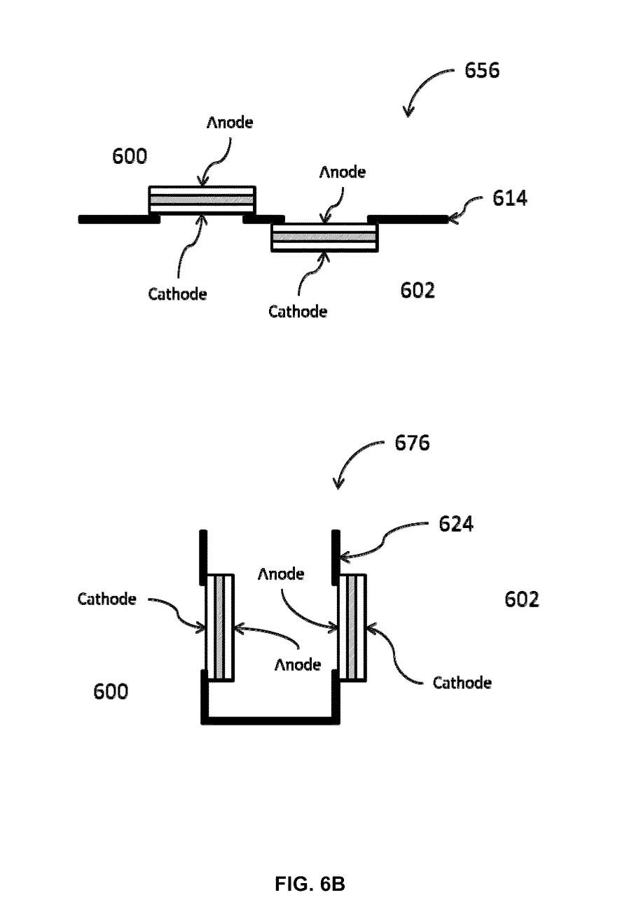

FIGS. 6A and 6B are diagrams showing some embodiments of two fuel cells connected together in a fuel cell system. For clarity, the connections shown are all serial connections but the techniques shown may be used to connect fuel cells in parallel if desired. In some embodiments, three or more fuel cells are combined in series (parallel). For clarity the electrical connections providing access to power generated by the fuel cells are not show.

In diagram 650, fuel cells 600 and 602 are connected together using mesh 604. In some embodiments, mesh 604 is a stainless steel mesh (e.g., AISI 300 series or AISI 400 series stainless steel). Fuel cells 600 and 602 may be connected to mesh 604 in a variety of ways such as welding, brazing, bonding, etc. In some embodiments an electrical connection is made between the cathode of fuel cell 600 and the anode of fuel cell 602 by the mesh. In other embodiments fuel cells 600 and 602 are bonded to the mesh but electrically insulated from the mesh and an electrical connection (not shown) must be made between the cathode of fuel cell 600 and the anode of fuel cell 602. For example, in some embodiments, one end of a wire is connected to the cathode of fuel cell 600 and the other end of the wire is connected to the anode of fuel cell 602. In some embodiments, once the fuel cells are connected to the mesh and the two fuel cells are electrically connected in series, the mesh with the fuel cells attached is connected to the container, for example, by welding, brazing, or bonding. Sealant 606 is then applied to the edges of fuel cells 600 and 602, making contact with fuel cells 600 and 602 and penetrating into mesh 604 so that the components in the system are further securely attached. In some embodiments, sealant 606 is an electrical insulator to prevent electrical shorting.

In some embodiments, the technique described above is attractive because the manufacturing technique produces a rugged product and/or the assembly technique is relatively simple and/or low cost (e.g., it can be done manually by a low cost labor pool).

Diagram 652 shows two fuel cells in the same plane connected together using a jog connector (608). Jog connector 608 in this example is cuboid in shape and includes an internal electrical connection (shown in black) connecting the cathode of fuel cell 600 to the anode of fuel cell 602. In some embodiments, jog connector 608 is manufactured at the same time or with fuel cells 600 and 602 so that jog connector 608 lines up with the anode of fuel cell 602 and the cathode of fuel cell 600. In some embodiments, jog connector 608 is manufactured separately from the fuel cells (e.g., based on nominal or expected dimensions of the anode and cathode) and jog connector 608 is connected during assembly to fuel cells 600 and 602.

Diagram 654 shows fuel cells 600 and 602, which are in the same plane, connected together with an electrical connection (610). Electrical connection 610 connects the cathode of fuel cell 600 to the anode of fuel cell 602. In various embodiments, electrical connection 610 is connected to fuel cells 600 and 602 by a variety of means such as welding, sealant, etc. Electrical connection 610 is connected to both fuel cells and then sealant 612 is applied over electrical connection 610 and (at least in this example) touches the edges of fuel cell 600 and fuel cell 602.

Diagram 656 shows fuel cells 600 and 602 connected together using a sheet 614 with holes or opening for the fuel cells. In some embodiments, sheet 614 is stainless steel (e.g., AISI 300 series or AISI 400 series stainless steel). Fuel cells 600 and 602 may be connected to sheet 614 in a variety of ways such as welding, brazing, bonding, etc. In some embodiments an electrical connection is made between the cathode of fuel cell 600 and the anode of fuel cell 602 by the sheet. In other embodiments fuel cells 600 and 602 are bonded to the sheet but electrically insulated from the sheet and an electrical connection (not shown) must be made between the cathode of fuel cell 600 and the anode of fuel cell 602. For example, in some embodiments, one end of a metal strip or wire is connected to the cathode of fuel cell 600 and the other end of the metal strip or wire is connected to the anode of fuel cell 602. In some embodiments, once the fuel cells are connected to the sheet and the two fuel cells are electrically connected in series, the sheet with the fuel cells attached is connected to the container, for example, by welding, brazing, or bonding. In some embodiments an electrically insulating sealant is applied to the edges of fuel cells 600 and 602 (not shown).

Diagram 676 shows fuel cells 600 and 602 electrically connected together as in Diagram 656 using a shaped container 624 with holes or openings for the fuel cells rather than a flat sheet. Additional geometries and electrical connections are possible and we do not wish to be limited by the ones shown.

In another embodiment, the anode of one cell directly contacts the cathode of the adjacent cell. Electrical and mechanical contact between the cells may be enhanced by applying pressure, welding, brazing, etc.

As described above, the diagrams show exemplary arrangements and may be combined or modified with other techniques shown in this or other figures. For example, although diagram 650 shows fuel cells 600 and 602 placed on different sides of the mesh, in some other embodiments the fuel cells are placed on the same side of the mesh (although perhaps oriented differently than shown).

Alternatively, if a load requires a minimum voltage which exceeds the voltage capable of being produced by a single fuel cell or fuel cells in series, then a voltage multiplier circuit can be attached to the electrical connections. In this manner a single fuel cell or two fuel cells connected in series can be connected with a voltage multiplier circuit into a fuel cell system than can be used to charge a cell phone, an LED light, or charge a battery.

The fuel cells may be attached to a fuel storage container in a removable manner as shown in FIG. 3B or the fuel cell (or multiple fuel cells) may be attached to a flat sheet with holes or opening for the fuel cells to facilitate the removal and insertion of the fuel cell region. A removable fuel cell region that comprises a flat sheet with one or more openings with one or more fuel cells attached is a “fuel cell card”. If there is more than one fuel cell attached to the sheet the fuel cells can be connected in series or parallel. The fuel cell card can function as a lid, or the lid can comprise the card.

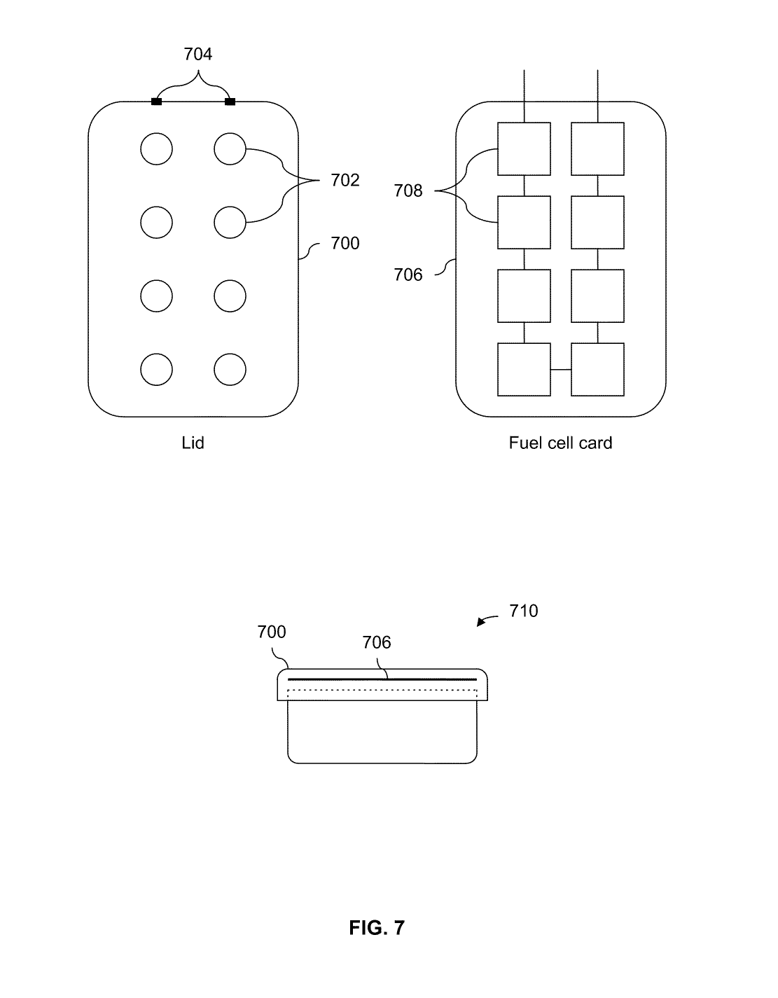

FIG. 7 is a diagram showing an embodiment of a fuel cell system with a removable fuel cell card. In the example shown, lid 700 includes 8 air vents (702). The air vents are positioned to line up with fuel cells 708 in fuel cell card 706 when fuel cell card 706 is inserted into or otherwise placed next to lid 700. In this example air vents 701 are circular but any shape or type of air vents may be used. Lid 700 in this example also includes electrical connection access 704 for the electrical connections coming off of fuel cell card 706. In various embodiments, electrical connection access 704 is a notch or hole in the lid so that the electrical connections are not bent when the fuel cell card in inserted and the lid is closed.

In this example, fuel cell card 706 has 8 fuel cells which are connected in series. So, if (as an example) each fuel cell generates 1V then the fuel cell system shown here will generate an 8V output. Fuel cells in a fuel cell card may be connected in any way desired. In another example, there are two groups of 4 fuel cells with the 4 fuel cells connected together in series (e.g., the four fuel cells in the left and right columns are connected in series, respectively) and the two groups of 4 fuel cells are connected together in parallel, producing a 4V output (again using 1V per fuel cell as an example). In some applications, having fuel cells connected in parallel is desirable because this creates redundancy and so the system can still operate even if one or more of the fuel cells fail.

Fuel cell system 710 shows the system with lid 700 closed and fuel cell card 706 in place. In this example there is a single fuel cell card but in other embodiments two or more fuel cell cards can be used. In some embodiments, there is a fuel cell card for the bottom of the fuel storage container and/or any of the other surfaces or walls.

In some embodiments, fuel cell card 706 has a message, instruction, or warning to help a user properly insert or align fuel cell card 706 with lid 700 so that the cathodes of the fuel cells are facing outwards and the anodes of the fuel cells are facing inwards. In some embodiments, the cathode side of the fuel cell card says “wrong way” so that if the user inserts the card with the cathode side facing inwards (which is not correct) the user will see the warning and reverse the card. In other embodiments, other warnings, messages or instructions are used. In one example, a first icon (e.g., a circle) may be printed or pressed into the lid and a second icon (e.g., a square) is put on the bottom of the fuel storage container. One side of the fuel cell card will have the first icon and the other side will have the second icon so that when the icons are matched up (e.g., circle to circle and square to square) the fuel cell card is oriented properly. In some embodiments, physical or visual cues are used to help a user orient a fuel cell card properly. In some embodiments, both the lid and the fuel cell card are convex and there is only one logical way for the fuel cell card to be inserted. In some embodiments, there is some clip or latch connecting the lid to the fuel cell card and the connection is designed so that the fuel cell card can only be connected in one manner.

In other embodiments, fuel cell card 706 is shaped in a manner that indicates the proper orientation to insert it into the fuel storage container. For example, the card may have holes, perforations, etc that fit around registration pins or tabs in the fuel storage container. Alternatively, both the fuel cell card 706 and fuel storage container may be shaped such that the fuel cell card will only fit into the fuel storage container in the correct orientation. Asymmetric shapes are especially useful. For example, both the fuel cell card and fuel storage container may be rectangular with one rounded corner and three square corners.

In some embodiments the fuel cell is a symmetric catalyst fuel cell and so there is no need to differentiate between cathode side and the anode side when inserting the fuel cell card.

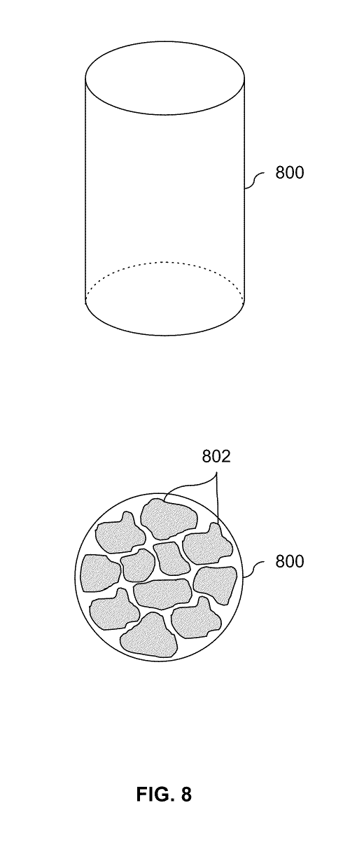

FIG. 8 is a diagram showing an embodiment of a cylindrical fuel storage container. For clarity, other components of a fuel cell system (such as a fuel cell, electrical connections, etc.) are not shown in this example. In the example shown, fuel cell container 800 is in the shape of a cylinder and fuel 802 is contained in the body of the cylinder. In various embodiments, fuel cells are connected to various surfaces of the cylinder, such as the (flat) top or bottom surface or along the curved surface of the cylinder. In various embodiments, some or all of the cylindrical wall comprises a tubular fuel cell. For example, an upper portion of the cylindrical wall may be a tubular fuel cell and a lower portion may be a heat conducting region. The cylindrical wall may also comprise multiple tubular fuel cells connected in series, with or without heat conducting regions between the cells. In these configurations, the anode of the tubular fuel cell is on the inside of the cylindrical wall, facing the fuel.

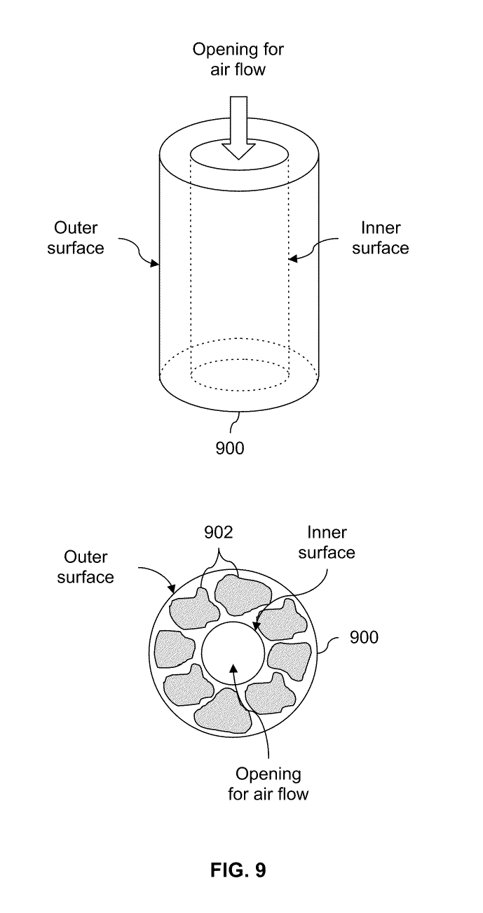

FIG. 9 is a diagram showing an embodiment of a fuel storage container in the shape of concentric cylinders. As in the previous figure, some components of a fuel cell system (such as a fuel cell, electrical connections, etc.) are not shown here. Fuel storage container 900 comprises an inner surface in the shape of a cylinder and an outer surface also in the shape of cylinder. Fuel 902 is stored between the inner and outer surfaces of the fuel storage container and the cylindrical space within the inner surface is an opening for air flow. In various embodiments, fuel cells are connected to various surfaces such as the inner surface, the outer surface, or the (flat) top or bottom surfaces. In various embodiments, some or all of the cylindrical inner or outer surface comprises a tubular fuel cell. In one embodiment, some or all of the inner cylindrical surface comprises a tubular fuel cell. For example, a lower portion of the inner cylindrical surface may be a tubular fuel cell and an upper portion may be a heat conducting region. The inner cylindrical surface may also comprise multiple tubular fuel cells connected in series, with or without heat conducting regions between the cells. In these configurations, the anode of the tubular fuel cell is on the outside of the inner cylindrical surface, facing the fuel.

The fuel storage container and lid may comprise any heat-resistant material, including but not limited to ceramic, clay, glass, refractory materials, and metals. The electrical connections and mesh comprise metal. Outside of the hotzone, the metal may be copper, or alloys thereof. Metallic system components that will be exposed to heat, including the fuel storage container, lid, electrical connections, mesh, and fuel cell card, are fabricated from heat-resistant metals. Metals that may be used include alloys comprising Ni, Cu, Cr, or Fe. Examples include Fe—Cr based alloys, Ni—Cr based alloys, stainless steel, and nickel superalloys. Stainless steels such as AISI 300 series or AISI 400 series are particularly useful because of their low cost and excellent mechanical and oxidation properties at high temperature.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for generating electrical power comprising:
a fuel storage container having an inside and an outside including:
a wall including:
a heat conducting region configured to allow heat from an external heat source to be conducted into the fuel storage container; and
a fuel cell region associated with a fuel cell having two sides, one side of the fuel cell exposed to the outside of the fuel storage container and one side of the fuel cell exposed to the inside of the fuel storage container, wherein the wall is to configured to isolate the inside of the fuel storage container from the environment outside the fuel storage container; and
an opening for receiving a fuel load for storage in the fuel storage container;
the fuel cell having two sides; and
an electrical connection providing access to power generated by the fuel cell.

2. The system of claim 1, wherein the fuel cell includes one or more of the following: a solid oxide fuel cell, a metal-supported solid oxide fuel cell (SOFC), a symmetric structure fuel cell, a symmetric catalyst composition fuel cell, or a thin film electrolyte fuel cell.

3. The system of claim 1, wherein the system is configured to operate on one or more of the following: solid fuel, biomass, a fuel derived from biomass, animal or human solid waste, charcoal, wood, or coal.

4. The system of claim 1, wherein the fuel cell is connected to the fuel storage container using one or more of the following: a sealant, a weld, a braze, a fastener, or hardware.

5. The system of claim 1 further comprising a lid configured to cover the opening for receiving a fuel load.

6. The system of claim 1 further comprising a first set of one or more fuel cells and a second set of one or more fuel cells connected together in series.

7. The system of claim 1 further comprising a first set of one or more fuel cells and a second set of one or more fuel cells connected together in electrical parallel.

8. The system of claim 1, wherein the fuel cell is removable.

9. The system of claim 8, wherein the fuel cell is part of a removable fuel cell card.

10. The system of claim 8 further comprising a lid.

11. The system of claim 1, wherein the fuel cell is a first fuel cell and the system further includes:
a second fuel cell having two sides; and
a metal sheet for mounting the first fuel cell and the second fuel cell, wherein the first fuel cell and the second fuel cell are mounted such that both sides of the first fuel cell and the second fuel cell are exposed, wherein:
the first fuel cell is connected in electrical series to the second fuel cell.

12. The system of claim 11, wherein the first fuel cell is connected to one side of the metal sheet and the second fuel cell is connected to the other side of the metal sheet.

13. The system of claim 11, wherein the fuel cell card includes a graphic and/or text associated with properly inserting the fuel cell card into a fuel cell system.

14. The system of claim 11, wherein the fuel cell card is shaped to properly align into a fuel is cell system.

15. A method for assembling a fuel cell system comprising:
using a processor to connect a fuel cell having two sides to an electrical connection providing access to power generated by the fuel cell; and
using a processor to connect the fuel cell to a fuel storage container wherein the fuel storage container has an inside and an outside including:
a wall including:
a heat conducting region configured to allow heat from an external heat source to be conducted into the fuel storage container; and
a fuel cell region associated with the fuel cell having two sides, one side of the fuel cell exposed to the outside of the fuel storage container and one side of the fuel cell exposed to the inside of the fuel storage container, wherein the wall is configured to isolate the inside of the fuel storage container from the environment outside the fuel storage container; and
an opening for receiving a fuel load for storage in the fuel storage container.
